(19) United States
(12) Patent Application Publication
(10) Pub. No.: US 2020/0338944 A1
(43) Pub. Date: Oct. 29, 2020

(54) MIRROR SYSTEM FOR A HEAD-UP DISPLAY

(71) Applicant: VISTEON GLOBAL TECHNOLOGIES, INC., Van Buren Township, MI (US)

(72) Inventors: Fabrice HENON, CERGY (FR); Yves LAMBERT, Jouy-le-Moutier (FR); David RENAUDIN, Us (FR)

(73) Assignee: VISTEON GLOBAL TECHNOLOGIES, INC.

(21) Appl. No.: 16/395,492

(22) Filed: Apr. 26, 2019

(51) Int. Cl. B60G 7/00; G02B 27/01; B60R 1/02

(52) U.S. Cl. CPC B60G 7/005; B60R 1/02; G02B 27/0149

(57) ABSTRACT

A head-up display for a vehicle may include a mirror system. The mirror system may include a mirror. The mirror may be rotatable about a first axis. For rotation about the first axis, the mirror system may include a first joint assembly spaced from a second joint assembly. The first joint assembly may include a bearing-ball joint aligned along a second axis. Additionally, the first joint assembly may include a mirror-ball joint aligned along the first axis. The mirror-ball joint may restrict movement of the bearing-ball joint to ensure that the first axis remains coaxial with the second axis.

### FIELD

One or more embodiments herein generally describe a mirror system, such as for a head-up display in a vehicle.

### RELATED ART

A vehicle may include a head-up display for showing graphical information to an occupant. The head-up display may include a conventional mirror system. The conventional mirror system may include a mirror. The mirror may be configured to rotate about a first axis. The conventional mirror system may include a first joint assembly. The first joint assembly may include a mirror-ball joint and a bearing-ball joint.

For the mirror-ball joint, the mirror system may include an arm. The arm may extend from a frame for the mirror. The arm may terminate at a spherical ball. As such, the arm may include the spherical ball at an end distal to the frame. The arm may be aligned along the first axis. The mirror-ball joint may include a socket for receiving the spherical ball of the arm.

The bearing-ball joint may receive the socket of the mirror-ball joint. The bearing-ball joint may include one or more ball bearings that rest against an outer surface of the socket of the mirror-ball joint. An intermediate retainer may be positioned over the one or more ball bearings. The intermediate retainer and the socket of the mirror-ball joint may prevent the one or more ball bearings from falling out of the bearing-ball joint. In the bearing-ball joint, a housing may receive the intermediate retainer. The housing may be mounted to a structure of the head-up display. As such, the housing may not move.

While the arm may be aligned on the first axis, the bearing-ball joint may be aligned along a second axis. The first axis and the second axis may intersect at a center of the spherical ball. The second axis may not coincide with the first axis. When the second axis fails to coincide with the first axis, the mirror system results in a misalignment condition.

In the first-joint assembly, the intermediate retainer may move relative to the housing. Movement of the intermediate retainer may change the positioning of the second axis. Additionally, movement of the intermediate retainer may change the positioning of the socket in relation to the spherical end. This may result in a displacement of the mirror. Additionally, this may result in a swing condition, which may yield a low first resonance frequency for the mirror system.

The misalignment condition and the possible movement may impact the performance of the head-up display, particularly in regards to showing graphical information. For example, the misalignment condition and the possible movement may impact positioning of the graphical information. Additionally, this may result in a jitter effect associated with the graphical information. In regard to the graphical information, all of this may be noticeable by the occupant, who, in response, may desire improved performance of the head-up display.

### SUMMARY

One or more embodiments may include a mirror system for a head-up display. The mirror system may include a mirror aligned along an axis. The mirror system may include a frame for holding the mirror. The mirror system may include an arm, for a joint assembly. The arm may extend from the frame and include an end that is distal to the frame. The arm may include a protrusion spaced between the end and the frame. The arm may include an extension member that is proximal to the end, adjacent to the protrusion, and distal to the frame. As such, the extension member may be in a region of the arm that is distal to the frame. Compared to the protrusion, the extension member may include a cross-sectional area that is less than a cross-sectional area of the protrusion.

One or more embodiments may include a mirror system for a head-up display. The mirror system may include a mirror that is rotatable about a first axis. The mirror system may include a frame for holding the mirror. The mirror system may include a joint assembly for rotating the mirror about the first axis. The joint assembly may include a bearing-ball joint that is aligned along a second axis. The joint assembly may include a mirror-ball joint aligned that is aligned along the first axis. The mirror-ball joint may restrict movement of the bearing-ball joint to ensure that the first axis is coaxial with the second axis. As such, the first axis may remain coaxial with the second axis. This may result from an arm of the mirror-ball joint. The arm may extend from the frame and include an end that is distal to the frame. The arm may include a protrusion that is spaced between the end and the frame. The arm may include an extension member that is between the end and the protrusion.

Maintaining the alignment of the first axis and the second axis, such that the first axis remains coaxial with the second axis, may improve the performance of the head-up display. For example, maintain the alignment of the first axis and the second axis may eliminate any displacement of the mirror. Additionally, this may eliminate a swing condition and resonance issues. Furthermore, from a viewer's perspective, maintaining the alignment may eliminate a jitter effect associated with graphical information. As such, through one or more of the embodiments herein, the displaying, such as positioning, of the graphical information may be improved.

According to certain embodiments, a system can include a bearing ball joint. The system can also include a mirror ball joint disposed within the bearing ball joint. The mirror ball joint can include an extension configured to ensure coaxiality of the mirror ball joint and the bearing ball joint.

In certain embodiments, a method can include providing a bearing ball joint. The method can further include disposing a mirror ball joint within the bearing ball joint. The mirror ball joint can include an extension configured to ensure coaxiality of the mirror ball joint and the bearing ball joint.

### BRIEF DESCRIPTION OF THE DRAWINGS

The accompanying drawings are provided for purposes of illustration and not by way of limitation.

FIG. 1A and FIG. 1B illustrate a bearing-ball joint of a conventional mirror system.

FIG. 2 illustrates a partial perspective view of a head-up display, in accordance with one or more embodiments.

FIG. 3A illustrates a partial cross-sectional view of a first joint assembly of a mirror system for a head-up display, which is in accordance with one or more embodiments.

FIG. 3B illustrates a partial cross-sectional view of a second joint assembly of a mirror system for a head-up display, which is in accordance with one or more embodiments.

FIG. 4 illustrates a frame of a mirror system for a head-up display, which is in accordance with one or more embodiments.

FIG. 5 illustrates a cross-section view a first joint assembly of a mirror system for a head-up display, which is in accordance with one or more embodiments.

FIG. 6 illustrates a cross-section view of a system according to certain embodiments.

FIG. 7 further illustrates a simplified view of a system according to certain embodiments.

### DETAILED DESCRIPTION

Certain embodiments may represent an improvement to the inventors' own previous work, which is described herein as “conventional,” without suggesting or admitting that work as prior art.

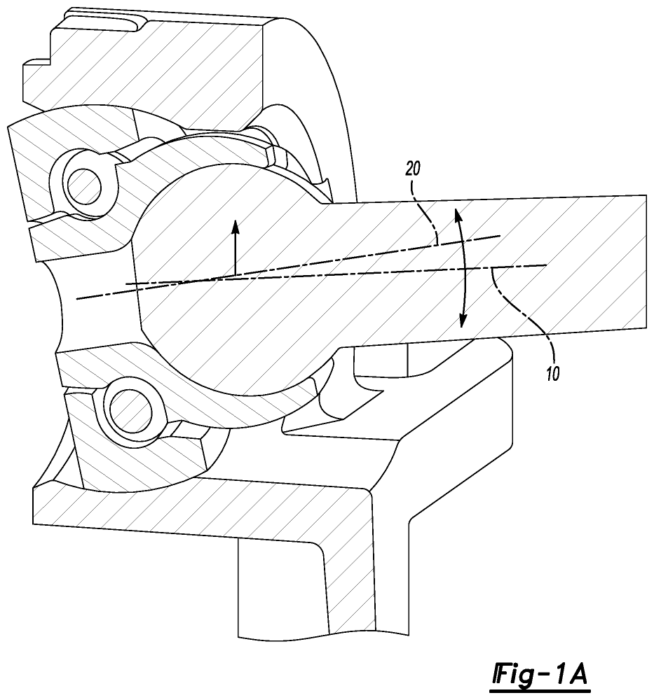

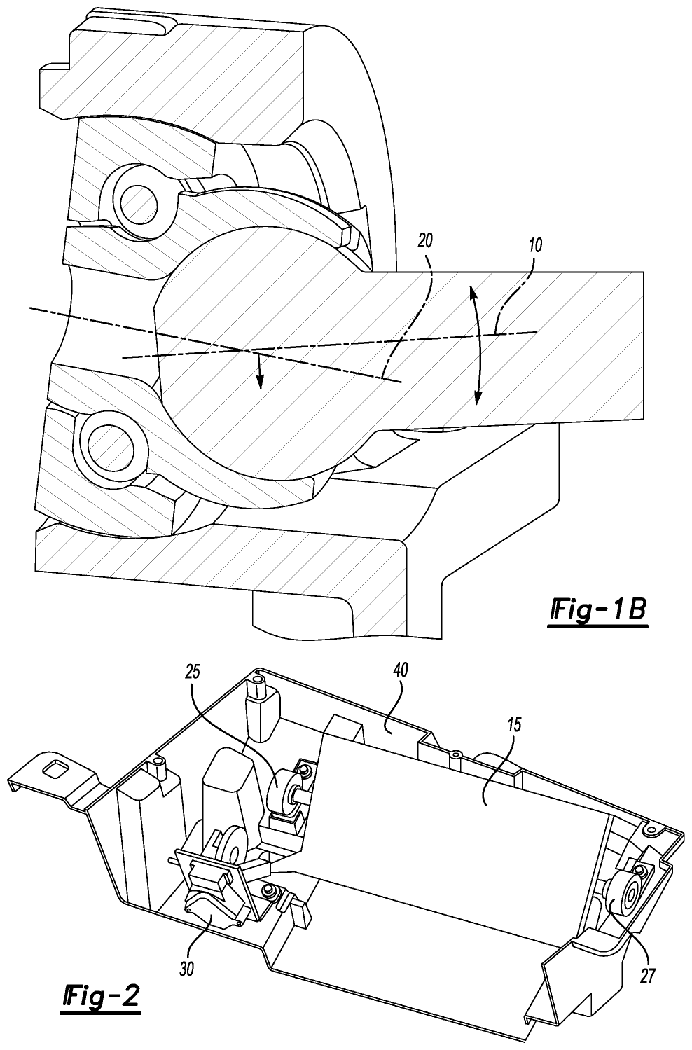

FIG. 1A and FIG. 1B illustrate a bearing-ball joint of a conventional mirror system. As shown in these figures, in the illustrated approach a mirror axis 10 may not be aligned with a bearing ball joint axis 20, because the mirror may move freely within the bearing. As shown in FIG. 1A, when the entire mirror axis moves up, the bearing ball joint may simply rotate to permit this. Similarly, as shown in FIG. 1B, when the entire mirror axis moves down, the bearing ball joint may once again rotate to permit this. Accordingly, the entire mirror axis may have some vertical play permitted by the bearing ball joint axis.

FIG. 2 illustrates a partial perspective view of a head-up display, in accordance with one or more embodiments. As shown in FIG. 2, a mirror 15 can be supported by a first bearing 25 and a second bearing 27. The mirror can be moved using actuator 30. The actuator 30 and the first bearing 25 and second bearing 27 may be mounted in a housing 40. This housing 40 may, for example, form a recess of a dashboard of a vehicle.

First bearing 25 is a bearing that may be particularly affected by certain embodiments. In particular, without certain embodiments as will be discussed below, the mirror 15 under forces from vibration of the vehicle, may move up and down within first bearing 25 as illustrated in FIGS. 1A and 1B.

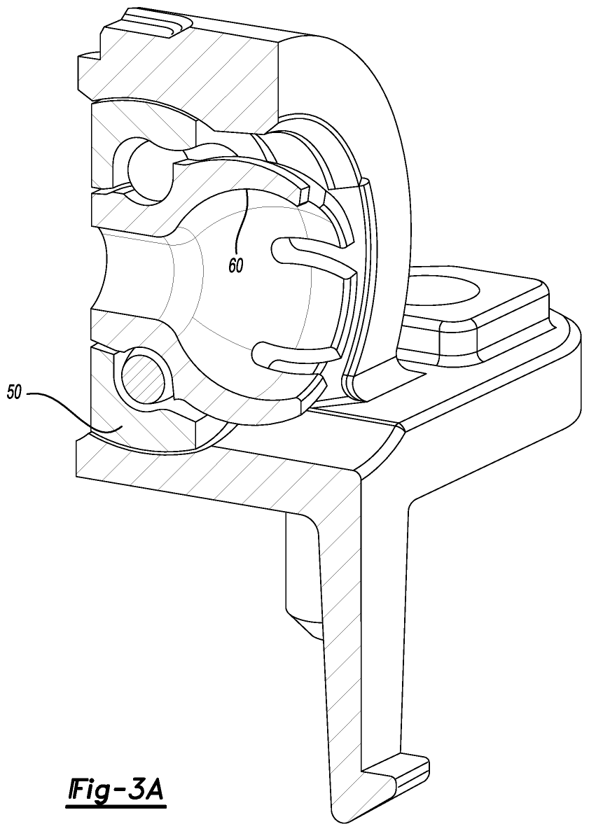

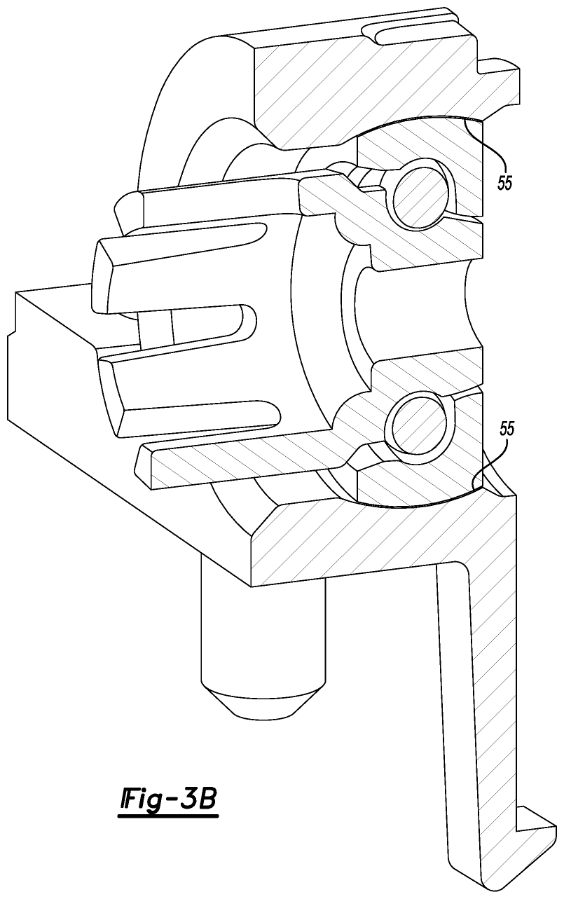

FIG. 3A illustrates a partial cross-sectional view of a first joint assembly of a mirror system for a head-up display, which is in accordance with one or more embodiments. As shown in FIG. 3A, a mirror ball joint 60 may be disposed within a bearing ball joint 50. This may correspond to the first bearing 25 in FIG. 2.

FIG. 3B illustrates a partial cross-sectional view of a second joint assembly of a mirror system for a head-up display, which is in accordance with one or more embodiments. As shown in FIG. 3B, a bearing ball joint 55 can be provided without a corresponding mirror ball joint. This bearing ball joint 55 may correspond to the second bearing 27 in FIG. 2.

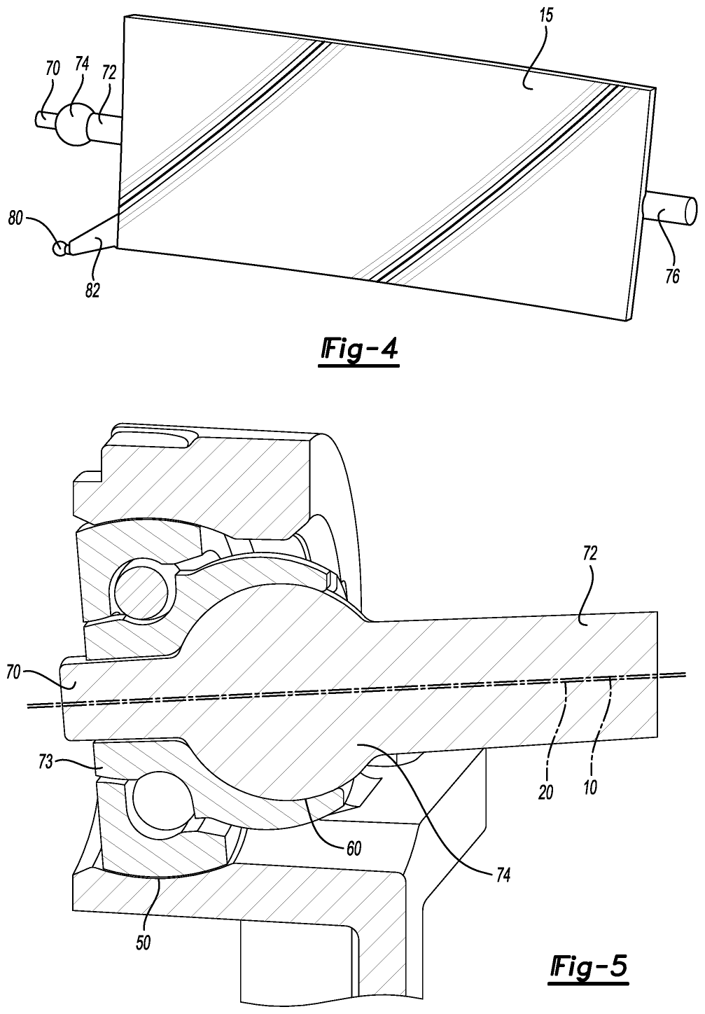

FIG. 4 illustrates a frame of a mirror system for a head-up display, which is in accordance with one or more embodiments. FIG. 4 shows mirror 15 (this may be the mirror element itself or a frame or substrate on which a mirror element is applied or mounted) having two shafts and an arm, specifically first mirror shaft 72, second mirror shaft 76, and actuator arm 82. The actuator arm 82 can be connected to mirror 15 at one and to actuator ball 80 at the other end. The actuator arm 82 and actuator ball 80 can be formed integral with the mirror 15. The actuator ball 80 can be moved by the actuator 30 illustrated in FIG. 2.

As shown in FIG. 4, the second mirror shaft 76 can be formed aligned with the first mirror shaft 72. The second mirror shaft 76 can be inserted into an opening in bearing ball joint 55 shown in FIG. 3B, whereas mirror ball 74 can be inserted into mirror ball joint 60 shown in FIG. 3A. The extension 70 protruding from mirror ball 74 can extend through mirror ball joint 60.

FIG. 5 illustrates a cross-section view a first joint assembly of a mirror system for a head-up display, which is in accordance with one or more embodiments. As shown in FIG. 5, when extension 70 of the first mirror shaft 72 and mirror ball 74 is inserted within retaining cylinder 73 of mirror ball joint 60, there can be a coaxial axis, meaning that mirror axis 10 and bearing ball joint axis 20 are identical within the tolerance of the fit of the extension 70 and retaining cylinder 73. No relative movement may be possible with a perfect fit and nearly no movement may occur with a fairly close fit.

Thus, according to certain embodiments, a system can include a bearing ball joint and a mirror ball joint disposed within the bearing ball joint. The mirror ball joint can include an extension configured to ensure coaxiality of the mirror ball joint and the bearing ball joint. An example of such an extension is extension 70, discussed above.

A shaft of the mirror ball joint can be connected at one side to a mirror. The mirror can be a mirror of a windshield head up display. The mirror can be a second shaft extending from an opposite side of the mirror from the shaft of the mirror ball joint. The second shaft can be coaxial with the shaft of the mirror ball joint. The second shaft can be supported by a cylindrical bearing arrangement (see, for example, FIG. 3B). The cylindrical bearing arrangement can include a set of roller bearings arranged around the second shaft.

The mirror can also include an actuator attached at a third point of the mirror (see, for example, actuator arm 82 in FIG. 4). The actuator can be configured to move the mirror about the axis defined by the mirror ball joint shaft and the second shaft. The third point can be at a corner of the mirror, where the corner is a corner of the edge on which the shaft of the mirror ball joint connects to the mirror. The actuator may also be connected to the mirror using a ball joint.

The extension of the mirror ball joint can extend from an opposite side of the shaft from the mirror. The extension can be a cylindrical extension. The cylinder can be a partially or completely hollow cylinder, or a full cylinder. The cylinder can have a smooth or grooved surface depending on desired friction characteristics with respect to the bearing ball joint. The bearing ball joint may include a corresponding passage configured to receive the extension. The passage may have the same length as the extension. Optionally, the extension may be shorter or longer than the passage.

The bearing ball joint can include a first outer sleeve defining a first semi-sphere cavity. The semi-sphere shell can have an outer surface configured to conform to an inner surface of the first outer sleeve. The bearing ball joint can include a plurality of bearings loaded in a first groove on an inner surface of the semi-sphere shell. The bearings can be, for example, ball bearings or roller bearings.

The mirror ball joint can include a second outer sleeve, wherein an outside surface of the second outer sleeve comprises a groove configured to support the plurality of bearings. The mirror ball joint can include a shaft having a ball portion. The second outer sleeve can include an inner surface having a second semi-sphere cavity configured to receive a ball portion of a shaft of the mirror ball joint.

The inner surface can also include a further cavity configured to receive the extension. The extension can include a protrusion of the shaft. The further cavity of the inner surface can be cylindrical and smooth and can be adapted to fit the extension. For example, the further cavity can define a cylinder and the extension can have a cylindrical outer dimension.

The length of the protrusion can be between half a radius of the second semi-sphere cavity and two radii of the semi-sphere cavity. For example, the protrusion can be approximately 1.5 radii of the semi-sphere cavity.

The shaft's thickness between the ball portion and the mirror can be the same as or twice the thickness of the protrusion. Thus, the shaft's dimensions can be generally similar in cross-section to the protrusion.

Certain embodiments can be variously implemented. For example, certain embodiments may be related to a system and method of stabilizing a mirror using a bearing and a ball-and-socket joint. The mirror may be part of a windshield heads up display. An extension on the ball of the ball-and-socket joint can pass through an opening in the socket to stabilize the joint and prevent a swing or displacement due to, for example, thermal expansion or other causes.

The system can include a windshield heads up display with a rotatable mirror. The mirror can include a shaft that has a bearing connection on one end and a ball-and-socket connection at the other end. The mirror can be rotated depending upon the operation of the heads up display system. This may be designed to permit projection of an image on the windshield for the driver to view or for other purposes. Thermal expansion may cause the shaft of the mirror to change length, causing the connection of the ball-and-socket joint to be displaced relative to the bearing connection on the opposite end of the shaft. An extension of the shaft through the ball-and-socket into an opening within the socket can provide for stabilization of the ball-and-socket joint during thermal expansion, for example. The extension can also maintain the position of the shaft on both ends, such that the mirror is properly positioned to display an image for the heads up display.

Certain embodiments may address various technological problems. For example, without the device according to certain embodiments, a displacement and/or a swing of the mirror can appear during a vibration test or under vibration conditions in usage. Vibrations associated with a first resonance frequency of the mirror may particularly pose a challenge.

Due to a lack of room, it may not be possible to have the center of the bearing ball joint and the center of the mirror sphere aligned. In this situation, these two centers may be able to move in different directions. When such a differential movement occurs, a coaxiality issue can appear. Moreover, when the two parts can move separately, a swing can occur and can lead to a low first resonance frequency of the mirror.

To solve this or other issues, an extension can be designed on the mirror. This extension can connect the two parts together and can prevent a displacement between the two parts. With this extension, coaxiality can be ensured as well.

As mentioned above, certain embodiments can relate to a mirror used in a windshield head up display. In a windshield head up display, a mirror is rotated using two bearings and an actuator. To compensate for thermal expansion and to ensure positioning, the mirror can be designed with a cylinder on one side of the rotation axis and a sphere on the opposite side. To compensate for a misalignment between the bearings and the mirror, a ball joint can be provided on each bearing.

As also mentioned above, due to a lack of room, and other feasibility constraints, the rotation axis of the bearing ball joint and the mirror ball joint may not be common. There may be a distance between the two rotation axes. This can lead to a possible displacement of the mirror independent of the bearing. This displacement can be characterized as a swing. This displacement or swing can decrease the level of the resonance frequency. A low resonance frequency can be an issue when it comes to reading a virtual image of a windshield head-up display (W-HUD).

These issues may be addressed in a variety of ways. In one aspect, the issues may be addressed by providing an extension of the mirror axis. This extension can help to prevent a displacement between the mirror and the bearing ball joint. This extension can, for example, ensure that the bearing ball joint axis and the mirror axis are coaxial. Furthermore, this extension can help prevent movement between the bearing ball joint and the mirror. Furthermore, first resonance frequency vibrations may be damped.

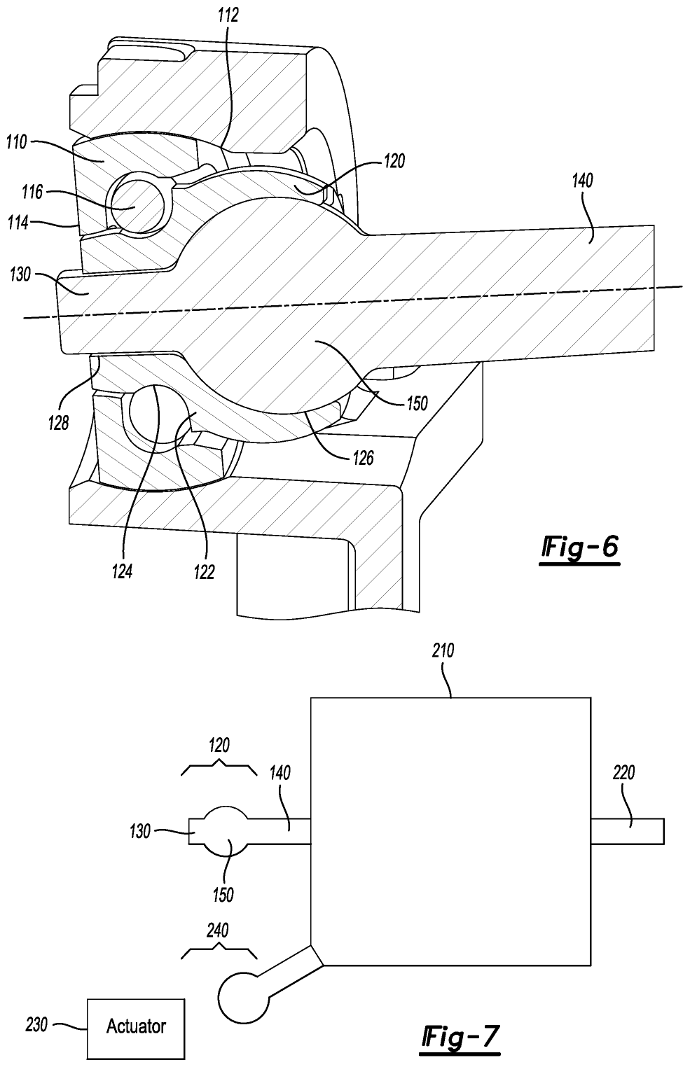

FIG. 6 illustrates a cross-section view of a system according to certain embodiments. The system of FIG. 6 may be similar to the system of FIG. 5. As shown in FIG. 6, a system can include a bearing ball joint 110 and a mirror ball joint 120 disposed within the bearing ball joint 110. The mirror ball joint 120 can include an extension 130 configured to ensure coaxiality of the mirror ball joint 120 and the bearing ball joint 110. The bearing ball joint 110 can include a corresponding passage, not shown, configured to receive the extension 130.

FIG. 7 further illustrates a simplified view of a system according to certain embodiments. As shown in FIG. 7, a shaft 140 of the mirror ball joint 120 can be connected at one side to a mirror 210. The extension 130 can extend from an opposite side of the shaft 140 from the mirror 210. The mirror 210 can be a mirror of a windshield head up display (not shown) of a vehicle, such as an automobile. The extension 130 can be a cylindrical extension. The mirror 210 can correspond to mirror 15 in FIG. 4.

The mirror 210 can include a second shaft 220 extending from an opposite side of the mirror 210 from the shaft 140 of the mirror ball joint 120. The second shaft 220 can be coaxial with the shaft 140 of the mirror ball joint 120. The second shaft 220 can be supported by a cylindrical bearing arrangement (not shown).

The mirror 210 can also include an actuator 230 attached at a third point of the mirror 210. The actuator 230 can be configured to move the mirror 210 about the axis defined by the mirror ball joint shaft 140 and the second shaft 220. The third point can be at a corner of the mirror, where the corner is a corner of the edge on which the shaft 140 of the mirror ball joint 120 connects to the mirror 210. The actuator 230 may also be connected to the mirror using a ball joint 240. The actuator 230 may correspond to actuator 30 in FIG. 2.

As shown in FIG. 6, the bearing ball joint 110 can include a first outer sleeve 112 defining a first semi-sphere cavity. The bearing ball joint 110 can include a semi-sphere shell 114 having an outer surface configured to conform to an inner surface of the first outer sleeve 112.

The bearing ball joint 110 can include a plurality of bearings 116 loaded in a first groove on an inner surface of the semi-sphere shell 114. The bearings 116 can be, for example, ball bearings (as shown in FIG. 6) or roller bearings.

The mirror ball joint 120 can include a second outer sleeve 122. An outside surface of the second outer sleeve 122 can include a groove 124 configured to support the plurality of bearings 116.

The mirror ball joint 120 can include a shaft 140 having a ball portion 150, wherein the second outer sleeve 122 comprises an inner surface 126 defining a second semi-sphere cavity configured to receive a ball portion 150 of a shaft 140 of the mirror ball joint 120.

The inner surface 126 can further include a further cavity 128 configured to receive the extension 130, wherein the extension 130 comprises a protrusion of the shaft 140. The further cavity 128 can define a cylinder and the extension 130 can have a cylindrical outer dimension. A length of the protrusion can be between half a radius of the second semi-sphere cavity and two radii of the semi-sphere cavity.

The shaft 140 can have a thickness between the ball portion 150 and the mirror 210. The thickness of the protrusion can be between half the thickness of the shaft 140 and the thickness of the shaft 140.

Although the above description has focused on a device and system, the method of using and making this system may be understood from the preceding discussion. For example, a method can include providing a bearing ball joint. The method can further include disposing a mirror ball joint within the bearing ball joint. The mirror ball joint can include an extension configured to ensure coaxiality of the mirror ball joint and the bearing ball joint.

What is claimed is:

1. A mirror system for a head-up display, the mirror system comprising:
a mirror aligned along an axis;
a frame configured to hold the mirror; and
an arm, for a joint assembly, extending from the frame and having an end distal to the frame, wherein the arm includes a protrusion spaced between the end and the frame.

2. The mirror system of claim 1, wherein the arm is aligned along the axis for rotating the mirror about the axis.

3. The mirror system of claim 1, wherein the arm includes an extension member that is proximal to the end, adjacent to the protrusion, and distal to the frame.

4. The mirror system of claim 3, wherein the extension member includes a cross-sectional area that is less than a cross-sectional area of the protrusion.

5. A mirror system for a head-up display, the mirror system comprising:
a mirror rotatable about a first axis;
a frame configured to hold the mirror; and
a joint assembly for rotating the mirror about the first axis and including:
a bearing-ball joint aligned along a second axis; and
a mirror-ball joint aligned along the first axis for restricting movement of the bearing-ball joint, wherein the first axis is coaxial with the second axis.

6. The mirror system of claim 5, wherein the mirror-ball joint includes an arm that extends from the frame, the arm having an end that is distal to the frame.

7. The mirror system of claim 6, wherein the arm includes a protrusion spaced between the end and the frame.

8. The mirror system of claim 7, wherein the arm includes an extension member between the end and the protrusion.

9. The mirror system of claim 8, wherein the mirror-ball joint includes a socket that receives the extension member and the protrusion.

10. The mirror system of claim 9, wherein the socket includes a first opening that receives the extension member and a second opening that receives the protrusion.

11. The mirror system of claim 10, wherein the socket includes a sleeve that defines the first opening and receives the extension member.

12. The mirror system of claim 11, wherein the socket includes a cup that defines the second opening and receives the protrusion.

13. The mirror system of claim 10, wherein the bearing-ball joint includes one or more ball bearings in contact with an exterior surface of the socket.

14. The mirror system of claim 10, wherein the bearing-ball joint includes an intermediate retainer that secures the one or more ball bearings against the socket.

15. The mirror system of claim 14, wherein bearing-ball joint includes a housing that receives the intermediate retainer and is secured to the head-up display.

16. The mirror system of claim 8, further comprising a second joint assembly spaced from the joint assembly and for rotating the mirror about the first axis.

17. The mirror system of claim 16, wherein the second joint assembly includes a bearing-ball joint aligned along the first axis.

18. The mirror system of claim 17, wherein the bearing-ball joint of the second joint assembly includes an arm that extends from the frame and is spaced from and opposite of the arm of the joint-assembly.

19. The mirror system of claim 18, wherein the bearing-ball joint of the second joint assembly includes a socket that receives the arm of the bearing-ball joint of the second joint assembly.

20. The mirror system of claim 19, wherein the bearing-ball joint of the second joint assembly includes one or more ball bearings, an intermediate retainer for the one or more ball bearings of the bearing-ball joint of the second joint assembly, and a housing for receiving the intermediate retainer of the bearing-ball joint of the second joint assembly, wherein the housing of the bearing-ball joint of the second joint assembly is secured to the head-up display.
